(19) United States
(12) Patent Application Publication
(10) Pub. No.: US 2025/0015312 A1
(43) Pub. Date: Jan. 9, 2025

(54) PLATINUM-CARBON CATALYST AND PREPARATION PROCESS AND USE THEREOF AND HYDROGEN FUEL CELL

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Xianrui GU, Beijing (CN); Houpeng WANG, Beijing (CN); Jiakang ZHANG, Beijing (CN); Qian PENG, Beijing (CN); Nanhong XIE, Beijing (CN)

(21) Appl. No.: 18/705,707

(22) PCT Filed: Oct. 31, 2022
(86) PCT No.: PCT/CN2022/128609

§ 371 Date: Apr. 29, 2024

(30) Foreign Application Priority Data
Oct. 29, 2021 (CN) 202111272257.9

(51) Int. Cl. H01M 4/92

(52) U.S. Cl. CPC H01M 4/926

(57) ABSTRACT

The present invention discloses a platinum-carbon catalyst and preparation process and use thereof and a hydrogen fuel cell with the platinum-carbon catalyst. A platinum-carbon catalyst contains a carbonaceous support and metallic platinum particles supported on the carbonaceous support. At least 50% of metallic platinum particles have a contact angle relative to the carbonaceous support of 70° or less. According to the platinum-carbon catalyst of the present invention, the metallic platinum particles have relatively good dispersion on the carbonaceous support, the catalyst has highly uniform cluster particles, and the metallic platinum and the carbonaceous support have a strong interaction each other, showing an improved electrochemical active surface area and a superior electrochemical stability. The process for preparing the platinum-carbon catalyst according to the present invention has the characteristics of batch repeatability and easy industrial scale-up, and can realize batch production of the platinum carbon catalyst.

### TECHNICAL FIELD

The present invention relates to a platinum-carbon catalyst and preparation process and use thereof, and the present invention also relates to a hydrogen fuel cell using the platinum-carbon catalyst.

### BACKGROUND OF ART

In fuel cell technology, catalysts are the core key materials. During the operation of fuel cells, there are activation polarization, concentration polarization, permeation polarization, and ohmic polarization. Activation polarization is the most significant of all polarizations, which is caused by the relatively low exchange current density of the oxygen reductive reaction (ORR) at the cathode.

So far, the most effective oxygen reducing catalyst is a platinum-carbon catalyst. The synthesis methods of platinum-carbon catalyst reported in the literature mainly include immersion method, high-temperature calcining method, vacuum sputtering method, ion-exchange method, electrochemical deposition method, sol-gel method, gas-liquid phase reduction method, glow discharge plasma method, displacement method, microwave-promoted reduction method, etc. These methods have their own advantages and disadvantages, but they all have certain problems during the engineering amplification. The support is a very important component in fuel cell catalysts. The synergistic effect between the support and the metallic catalyst can enhance the catalyst performance. The instability of platinum-carbon catalysts is essentially due to the weak interaction between the metallic platinum particles and the carbon support. Enhancing the interaction between the metallic platinum and the carbon support is one of the keys to improving the stability of the catalyst.

Therefore, there is an urgent need in this field to develop a process for batch production of platinum-carbon catalysts that can not only enhance the interaction between the metallic platinum and the carbon support, thereby improving the stability of platinum-carbon catalysts but also batch-produce platinum-carbon catalysts with high uniformity and high batch stability.

### SUMMARY OF THE INVENTION

The purpose of the present invention is to provide a platinum-carbon catalyst and preparation process thereof. The platinum carbon catalyst according to the present invention shows a strong interaction with the support, demonstrating an improved oxygen reduction activity and stability. The preparation process according to the present invention can produce the platinum-carbon catalyst with high uniformity and high batch stability, and in the prepared platinum-carbon catalysts, the metallic platinum and the support have a strong interaction each other, showing an improved oxygen reduction activity and stability.

According to the first aspect of the present invention, the present invention provides a platinum-carbon catalyst containing a carbonaceous support and metallic platinum particles supported on the carbonaceous support, wherein at least 50% of metallic platinum particles have a contact angle relative to the carbonaceous support of 70° or less.

According to the second aspect of the present invention, the present invention provides a process for preparing a platinum-carbon catalyst, wherein the process comprises the following steps:
S1. a carbonaceous material, a platinum precursor, a complexing agent and a dispersion medium are dispersed using ultrasonic wave to produce a first dispersion, the complexing agent is a carboxylate salt, the dispersion medium is C₂-C₄ dihydric alcohol and water, the volume ratio of the dihydric alcohol to water is 0.1-10:1, the molar ratio of the platinum precursor to the complexing agent is 1:0.1-10, wherein, the molar concentration of the platinum precursor relative to the dispersion medium is C₀, the molar concentration of platinum in the liquid phase of the first dispersion obtained from step S1 is C₁, C₁/C₀<0.5;
S2. the pH value of the first dispersion is adjusted to 8-14 to produce a second dispersion;
S3. a reducing agent is added to the second dispersion, so that the reducing agent comes into contact with the platinum precursor in the second dispersion for a reduction reaction, the reducing agent is an acidic organic reducing agent, the molar ratio of the reducing agent to the platinum precursor as platinum element is generally 5-1000:1.

According to the third aspect of the present invention, the present invention provides a platinum-carbon catalyst prepared with the process of the second aspect of the present invention.

According to the fourth aspect of the present invention, the present invention provides use of the platinum-carbon catalyst according to the first aspect or the third aspect of the present invention in fuel cell.

According to the fifth aspect of the present invention, the present invention provides a hydrogen fuel cell, wherein the anode and/or the cathode of the hydrogen fuel cell contain the platinum-carbon catalyst according to the first aspect or the third aspect of the present invention.

Specifically, the present disclosure provides the following technical solutions:
1. A platinum-carbon catalyst containing a carbonaceous support and metallic platinum particles supported on the carbonaceous support, characterized in that at least 50% of metallic platinum particles have a contact angle relative to the carbonaceous support of 700 or less, preferably, at least 55% of metallic platinum particles have a contact angle relative to the carbonaceous support of 70° or less, for example, 55-70% of metallic platinum particles have a contact angle relative to the support of 700 or less, or 60-70% of metallic platinum particles have a contact angle relative to the support of 700 or less;
further preferably, the contact angles of metallic platinum particles relative to the carbonaceous support are in the range of 400 to 70°;
based on the total amount of the platinum-carbon catalyst, the content of the metallic platinum is 20-70 wt %, the content of the carbonaceous support is 30-80 wt %; preferably, based on the total amount of the platinum-carbon catalyst, the content of the metallic platinum is 50-70 wt %, the content of the carbonaceous support is 30-50 wt %.

2. The platinum-carbon catalyst according to technical solution 1, wherein, metallic platinum particles in the platinum-carbon catalyst have an average particle size of 3-6 nm.

3. The platinum-carbon catalyst according to any one of technical solutions 1-2, wherein the platinum-carbon catalyst substantially consists of the carbonaceous support and metallic platinum particles supported on the carbonaceous support.

4. The platinum-carbon catalyst according to any one of technical solutions 1-3, wherein the platinum-carbon catalyst consists of the carbonaceous support and metallic platinum particles supported on the carbonaceous support.

In the present invention, the platinum-carbon catalyst (substantially) consisting of the carbonaceous support and metallic platinum particles supported on the carbonaceous support refers to that based on the weight of the platinum-carbon catalyst, the total weight of the carbonaceous support and metallic platinum particles comprises 90 wt % or more, 95 wt % or more, 96 wt % or more, 97 wt % or more, 98 wt % or more, 99 wt % or more.

5. The platinum-carbon catalyst according to any one of technical solutions 1-4, wherein the carbonaceous support is a conductive carbon black;
preferably, the conductive carbon black has a specific surface area of 200-2000 m²/g, preferably 250-1500 m²/g.

6. The platinum-carbon catalyst according to any one of technical solutions 1-5, wherein the platinum-carbon catalyst has an electrochemical active surface area of 70-120 m²·g⁻¹-Pt; and/or the platinum-carbon catalyst has a mass specific activity of 0.2 A·mg⁻¹-Pt or higher, preferably 0.2-0.25 A·mg⁻¹-Pt.

7. A process for preparing a platinum-carbon catalyst, the process comprises the following steps:
S1. a carbonaceous material, a platinum precursor, a complexing agent and a dispersion medium are dispersed (optionally with an ultrasonic wave) to produce a first dispersion, the complexing agent is a carboxylate salt, the dispersion medium is C₂-C₄ dihydric alcohol and water, the volume ratio of the dihydric alcohol to water is 0.1-10:1, the molar ratio of the platinum precursor to the complexing agent is 1:0.1-10; optionally, the dispersion obtained from step S1 has a pH value of 1-4;
S2. the pH value of the first dispersion is adjusted to 8-14 to produce a second dispersion;
S3. a reducing agent is added to the second dispersion, so that the reducing agent comes into contact with the platinum precursor in the second dispersion for a reduction reaction, the reducing agent is an acidic organic reducing agent, the molar ratio of the reducing agent to the platinum precursor as platinum element is generally 5-1000:1.

8. The process according to technical solution 7, wherein, in step S1, the molar concentration of the platinum precursor relative to the dispersion medium is C₀, the molar concentration of platinum in the liquid phase of the first dispersion obtained from step S1 is C₁, C₁/C₀<0.5, for example, C₁/C₀ is 0.15-0.49; preferably, C₁/C₀ is 0.15-0.45; more preferably, C₁/C₀ is 0.2-0.4.

9. The process according to any one of technical solutions 7-8, wherein, in step S1, the complexing agent is an alkali metal salt of monocarboxylic acid and/or an ammonium salt of monocarboxylic acid; preferably, the complexing agent is one or two or more of compounds represented by formula I,

R—COOM (formula I)
in formula I, R is hydrogen, C₁-C₆ alkyl or C₁-C₆ haloalkyl, M is alkali metal ion or ammonium ion; and/or
preferably, the complexing agent is one or two or more of sodium formate, sodium acetate, sodium monochloroacetate, sodium dichloroacetate and sodium trichloroacetate; and/or

The molar ratio of the platinum precursor to the complexing agent is 1:0.5-5, preferably 1:1-3.

10. The process according to any one of technical solutions 7-9, wherein, in step S1, a carbonaceous material, a platinum precursor, a complexing agent and a dispersion medium are dispersed using ultrasonic wave, relative to per 1 litre of dispersion medium, the ultrasonic wave has a power of 1-20 W, preferably 2-12 W; the duration time of the ultrasonic dispersion is 0.1-5 hours, for example 0.2-1 hours.

11. The process according to any one of technical solutions 7-10, wherein, in step S1, the volume ratio of dihydric alcohol to water is 0.5-5:1, or 1:0.5-5, or 0.67-3:1, or 1:1-3, and/or the dihydric alcohol is ethylene glycol, 1,2-propylene glycol, 1,3-propylene glycol, preferably, the dihydric alcohol is ethylene glycol.

12. The process according to any one of technical solutions 7-11, wherein, in step S1, the mass ratio of the platinum precursor to the dispersion medium is 1:100-5000, preferably 1:120-1000, more preferably 1:160-300.

13. The process according to any one of technical solutions 7-12, wherein, the process further comprises a step S0, in which the carbonaceous material in step S1 is pretreated, in step S0, the carbonaceous material is successively subjected to solvent treatment, first oxidizing treatment, second oxidizing treatment and high-temperature treatment, to produce a pretreated carbonaceous material, in the solvent treatment, the carbonaceous material is soaked in an organic solvent to produce an organic solvent-soaked carbonaceous material, preferably, the organic solvent is one or two or more of ketone solvents;
in the first oxidizing treatment, the organic solvent-soaked carbonaceous material comes into contact with a first oxidizing agent to produce a first oxidizing-treated carbonaceous material, the first oxidizing agent is one or two or more of hydrogen peroxide and organic peroxides represented by formulae II:

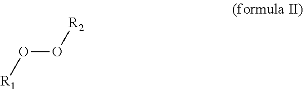

in formula II, R₁ and R₂ are each selected from H, C₄-C₁₂ alkyl, C₆-C₁₂ aryl, C₇-C₁₂ aralkyl and

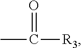

and R₁ and R₂ are not H at the same time, R₃ is C₄-C₁₂ linear or branched alkyl or C₆-C₁₂ aryl; in the second oxidizing treatment, the first oxidizing-treated carbonaceous material comes into contact with a second oxidizing agent to produce a second oxidizing-treated carbonaceous material, the second oxidizing agent is one or two or more of HNO₃ and/or H₂SO₄;
in the high-temperature treatment, the second oxidizing-treated carbonaceous material is calcined in an inert atmosphere at a temperature of 300-700° C., for example 300-600° C. (for example 400, 500, 600, or 700° C.) to produce a pretreated carbonaceous material.

14. The process according to technical solution 13, wherein, in step S0, in the solvent treatment, the duration time of the soaking is 5-24 hours (for example 8 hours), the mass ratio of the solvent to the carbonaceous material is 5-100:1 (for example 20:1 or 18:1); and/or
in the solvent treatment, the temperature of the organic solvent is 20-70° C., preferably 25-40° C. (for example 25 or 35° C.); and/or
in the solvent treatment, the organic solvent is acetone.

15. The process according to technical solution 13 or 14, wherein in step S0, in the first oxidizing treatment, the duration time of the contacting is 5-24 hours (for example 12 hours or 10 hours), the mass ratio of the first oxidizing agent to the organic solvent-soaked carbonaceous material is 5-30:1 (for example 25:1 or 20:1); and/or
in the first oxidizing treatment, the contacting is performed at a temperature of 20-70° C., preferably performed at a temperature of 25-40° C. (for example 25° C.); and/or
in the first oxidizing treatment, the first oxidizing agent is provided in form of an aqueous solution, the content of the first oxidizing agent in the aqueous solution is 5-30 wt % (for example 15 or 10 wt %); and/or
in the first oxidizing treatment, the first oxidizing agent is hydrogen peroxide.

16. The process according to any one of technical solutions 13-15, wherein, in step S0, in the second oxidizing treatment, the duration time of the contacting is 5-24 hours (for example 12 hours), the mass ratio of the second oxidizing agent to the first oxidizing-treated carbonaceous material is 5-50:1, preferably 10-30:1, more preferably 12-20:1 (for example 15:1 or 12:1); and/or
in the second oxidizing treatment, the contacting is performed at a temperature of 50-90° C. (for example 70 or 65° C.); and/or
in the second oxidizing treatment, the second oxidizing agent is nitrate acid, preferably the concentration of the nitrate acid is 25-68 wt %, preferably 30-40 wt % (for example 30 or 35 wt %).

17. The process according to any one of technical solutions 13-16, wherein in step S0, in the high-temperature treatment, the calcining temperature is 500-600° C. (for example 600° C.); and/or in the high-temperature treatment, the duration time of the calcining is 2-8 hours, preferably 3-6 hours (for example 4 hours).

18. The process according to any one of technical solutions 7-17, wherein, in step S1, the water-soluble platinum precursor is one or two or more of sodium chloroplatinite, ammonium hexachloroplatinate, potassium hexachloroplatinate, sodium hexachloroplatinate, platinum tetrachloride, tetraammineplatinum nitrate, platinum nitrate, chloroplatinic acid, potassium chloroplatinate and sodium chloroplatinate; and/or
in step S1, the carbonaceous material is a conductive carbon black, the conductive carbon black has a specific surface area of preferably 200-2000 m²/g, more preferably 250-1500 m²/g.

19. The process according to any one of technical solutions 7-18, wherein, in step S2, the pH value of the first dispersion obtained from step S1 is adjusted to 8-12, for example by addition of sodium carbonate, potassium carbonate or sodium hydroxide.

20. The process according to any one of technical solutions 7-19, wherein, in step S3, the reducing agent is one or two or more of formic acid, citric acid and tartaric acid, the reducing agent preferably contains formic acid, more preferably is formic acid; and/or
in step S3, the molar ratio of the reducing agent to the water-soluble platinum precursor is 50-600:1, or 80-400:1, or 100-200:1 (for example 200:1), the water-soluble platinum precursor is calculated as metallic platinum.

21. The process according to any one of technical solutions 7-20, wherein, in step S3, the reduction is performed at a temperature of 50-140° C., or at a temperature of 55-90° C., or at a temperature of 60-80° C. (for example, 75° C.); and/or in step S3, the duration time of the reduction is 2-12 hours (6 hours).

22. A platinum-carbon catalyst prepared with the process according to any one of technical solutions 7-21.

23. Use of the platinum-carbon catalyst according to any one of technical solutions 1-6 and 22 in fuel cell.

24. A hydrogen fuel cell, wherein the anode and/or the cathode of the hydrogen fuel cell contain the platinum-carbon catalyst according to any one of technical solutions 1-6 and technical solution 22.

The platinum-carbon catalyst according to the present invention and preparation process thereof can produce the following technical effects:

1. According to the platinum-carbon catalyst of the present invention, the metallic platinum particles have better dispersion on the carbonaceous support, the catalyst has highly uniform cluster particles, and the metallic platinum and the carbonaceous support have a strong interaction each other so that metallic platinum particles are anchored on the carbonaceous support. Therefore the platinum-carbon catalyst according to the present invention shows an improved electrochemical active surface area and a superior electrochemical stability.

2. The preparation process of the platinum-carbon catalyst according to the present invention has the characteristics of batch repeatability and easy industrial scale-up, and can realize the batch production of the platinum-carbon catalyst.

### DESCRIPTION OF THE DRAWINGS

FIG. 1 is a schematic diagram for explaining the contact angle between metal platinum and carbonaceous support in the platinum-carbon catalyst;

FIG. 2 is a TEM photo used to illustrate the contact angle between metal platinum and carbonaceous support in the platinum-carbon catalyst prepared in Example 1;

FIG. 3 is a TEM photo used to illustrate the contact angle between metal platinum and carbonaceous support in the platinum-carbon catalyst prepared in Comparative Example 1;

FIG. 4 is a TEM photo of the platinum-carbon catalyst prepared in Example 1 (based on the total amount of the platinum-carbon catalyst, the content of metallic platinum is 55 wt %);

FIG. 5 is a TEM photo of the platinum-carbon catalyst prepared in Comparative Example 1 (based on the total amount of the platinum-carbon catalyst, the content of metallic platinum is 55 wt %);

FIG. 6 is a statistical result of the particle size of metal platinum particles in a field of view of a transmission electron microscope photo of the platinum-carbon catalyst prepared in Example 1.

FIG. 7 is a TEM photo of a commercially available catalyst JM70%.

### DETAILED DESCRIPTION

The endpoints of ranges and any values disclosed herein are not limited to the precise ranges or values, but these ranges or values are to be understood to include values approaching such ranges or values. Moreover, for the numerical ranges, one or more new numerical ranges can be obtained by the combinations between any two endpoint values of the ranges, between an endpoint value of the ranges and a specific point value, and between any two specific point values. These numerical ranges shall be deemed to be specifically disclosed herein.

According to the first aspect of the present invention, the present invention provides a platinum-carbon catalyst containing a carbonaceous support and metallic platinum particles supported on the carbonaceous support.

According to the platinum-carbon catalyst of the present invention, the metallic platinum particles have good dispersion on the carbonaceous support, the catalyst has highly uniform metallic platinum cluster particles, and the metallic platinum particles and the support have a strong interaction.

According to the platinum-carbon catalyst of the present invention, at least 50% of metallic platinum particles have a contact angle relative to the support of 700 or less, for example, 50-75% of metallic platinum particles have a contact angle relative to the support of 700 or less. Preferably, at least 55% of metallic platinum particles have a contact angle relative to the support of 700 or less, for example, 55-70% of metallic platinum particles have a contact angle relative to the support of 700 or less. More preferably, at least 60% (for example 60-70%) of metallic platinum particles have a contact angle relative to the support of 70° or less. According to the platinum-carbon catalyst of the present invention, the contact angles of metallic platinum particles relative to the carbonaceous support are generally in the range of 400 to 70°.

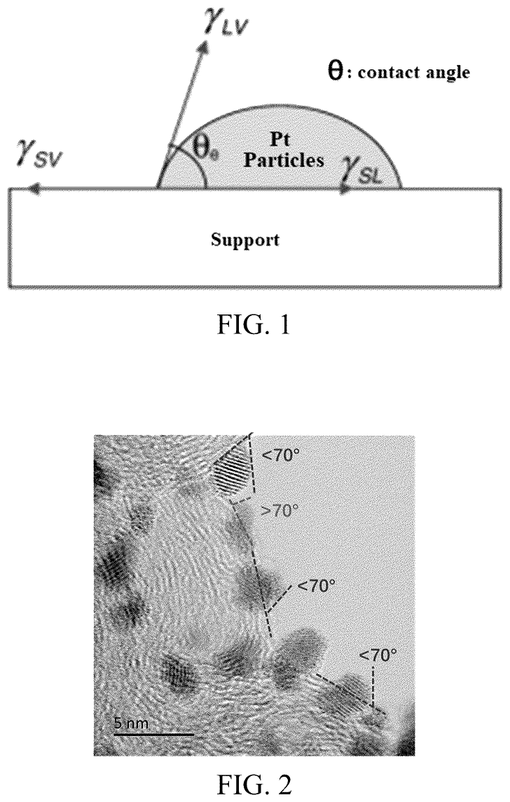

In the present invention, the specific definition of the contact angle of the metallic platinum particle relative to the carbonaceous support is as shown in FIG. 1, and the contact angle (0) is obtained from a straight line being the plane of the carbon layer and a tangent line plotted at the contact arc of the Pt particle and the carbon support surface. The present invention uses a profile image method based on the electron microscope to measure the contact angle between the metallic platinum particle and the carbonaceous support. The range of contact angle is 0°≤θ<180°.

According to the platinum-carbon catalyst of the present invention, metallic platinum particles in the platinum-carbon catalyst have an average particle size of 3-6 nm. In the present invention, the average particle size of metallic platinum particles in the platinum-carbon catalyst is determined with electronic transmission microscopy.

According to the platinum-carbon catalyst of the present invention, based on the total amount of the platinum-carbon catalyst, The content of the metallic platinum can be 20-70 wt %, preferably 30-70 wt %, more preferably 35-70 wt %, and the content of the carbonaceous support can be 30-80 wt %, preferably 30-70 wt %, more preferably 30-65 wt %. In a preferred embodiment, based on the total amount of the platinum-carbon catalyst, the content of the metallic platinum is 50-70 wt %, or 60-70 wt %, the content of the carbonaceous support is 30-50 wt %, or 30-40 wt %.

In the present invention, the contents of the platinum element and the carbonaceous support in the platinum-carbon catalyst are determined with the inductively coupled plasma (ICP) spectrometry.

According to the platinum-carbon catalyst of the present invention, the carbonaceous support is a conductive carbon black. The conductive carbon black can be one or two or more of ordinary-conductive carbon black, super-conductive carbon black, and extra-conductive carbon black.

Preferable examples of the conductive carbon black may include, but are not limited to one or two or more of Vulcan XC72, Ketjen EC300J, Ketjen EC600J, Blackpearls 2000 and Blackpearls 3000. The conductive carbon black has a specific surface area of preferably 200-2000 m²/g, more preferably 250-1500 m²/g. In the present invention, the specific surface area is determined using the BET method.

The platinum-carbon catalyst according to the present invention showed the increased electrochemical active surface area. The platinum-carbon catalyst according to the present invention has an electrochemical active surface area (ECSA) of 70 m²·g⁻¹-Pt or above, preferably 70-120 m²·g⁻¹-Pt, more preferably 80-120 m²·g⁻¹-Pt. The platinum-carbon catalyst according to the present invention has a mass specific activity of 0.2 A·mg⁻¹-Pt or higher, preferably 0.2-0.25 A·mg⁻¹-Pt.

According to the second aspect of the present invention, the present invention provides a process for preparing a platinum-carbon catalyst, wherein the process comprises the following steps:
S1. a carbonaceous material, a platinum precursor, a complexing agent and a dispersion medium are dispersed using ultrasonic wave to produce a first dispersion;
S2. the pH value of the first dispersion is adjusted to 8-14 to produce a second dispersion;
S3. a reducing agent is added to the second dispersion, so that the reducing agent comes into contact with the platinum precursor in the second dispersion for a reduction reaction.

In step S1, the platinum precursor can be a platinum compound that can be reduced to metallic platinum by a reducing agent under reduction reaction conditions. According to the process of the present invention, the platinum precursor can be one or two or more of sodium chloroplatinite, ammonium hexachloroplatinate, potassium hexachloroplatinate, sodium hexachloroplatinate, platinum tetrachloride, tetraammineplatinum nitrate, platinum nitrate, chloroplatinic acid, potassium chloroplatinate and sodium chloroplatinate. Preferably, the platinum precursor is chloroplatinic acid.

In step S1, the complexing agent is a carboxylate salt, the carboxylate salt is a water soluble salt of carboxylic acid. Preferably, the complexing agent is one or two or more of monocarboxylic acid salts, for example can be an alkali metal salt of monocarboxylic acid and/or an ammonium salt of monocarboxylic acid. The monocarboxylic acid salt is a water soluble salt of monocarboxylic acid. In the present invention, the complexing agent can be one or two or more of compounds represented by formula I,

R—COOM (formula I)
In formula I, R can be hydrogen, C₁-C₆ alkyl or C₁-C₆ haloalkyl, M is alkali metal ion or ammonium ion (—NH₄).

In the present invention, C₁-C₆ alkyl comprise C₁-C₆ linear alkyl and C₃-C₆ branched alkyl, its specific example may include, but are not limited to methyl, ethyl, n-propyl, isopropyl, n-butyl, sec-butyl, isobutyl, tertiarybutyl, n-pentyl, 2-methylbutyl, 3-methylbutyl, 2,2-dimethylpropyl, n-hexyl, 2-methylpentyl, 3-methylpentyl, 4-methylpentyl, 2,3-dimethylbutyl, 2,2-dimethylbutyl, 3,3-dimethylbutyl or 2-ethylbutyl.

In the present invention, the halogen atom in the haloalkyl can be fluorine, chlorine or bromine, preferably chlorine.

Specific example of the complexing agent may include, but are not limited to one or two or more of sodium formate, sodium acetate, ammonium acetate, sodium propionate, ammonium propionate, sodium butyrate, sodium valerate, sodium hexanoate, sodium monochloroacetate, sodium dichloroacetate and sodium trichloroacetate.

Preferably, the complexing agent is one or two or more of sodium formate, sodium acetate, sodium monochloroacetate, sodium dichloroacetate and sodium trichloroacetate. More preferably, the complexing agent is sodium formate and/or sodium acetate.

In step S1, the molar ratio of the platinum precursor to the complexing agent is preferably 1:0.1-10, more preferably 1:0.5-5, further preferably 1:1-3.

In step S1, the dispersion medium is C₂-C₄ dihydric alcohol and water. Preferably, the dihydric alcohol is ethylene glycol. In step S1, the volume ratio of dihydric alcohol to water can be 1:0.1-10, preferably 1:0.5-5, more preferably 1:1-3.

In step S1, the used amount of the dispersion medium can be selected based on the used amounts of the platinum precursor and the carbonaceous support. Preferably, in step S1, the mass ratio of the platinum precursor to the dispersion medium can be 1:100-5000, preferably 1:120-1000, more preferably 1:150-500, further preferably 1:160-300.

In step S1, the carbonaceous support is a conductive carbon black. The conductive carbon black can be one or two or more of ordinary-conductive carbon black, super-conductive carbon black, and extra-conductive carbon black. Preferable examples of the conductive carbon black may include, but are not limited to one or two or more of Vulcan XC72, Ketjen EC300J, Ketjen EC600J, Blackpearls 2000 and Blackpearls 3000. The conductive carbon black has a specific surface area of preferably 200-2000 m²/g, more preferably 250-1500 m²/g.

The used amount of the carbonaceous support and the platinum precursor can be selected based on the expected content of platinum introduced on the carbonaceous support. According to the process of the present invention, the carbonaceous support and the platinum precursor are used in such amounts that based on the total amount of the platinum-carbon catalyst, the content of the metallic platinum can be 20-70 wt %, preferably 30-70 wt %, more preferably 35-70 wt %, the content of the carbonaceous support can be 30-80 wt %, preferably 30-70 wt %, more preferably 30-65 wt %. In a preferred embodiment, the carbonaceous support and the platinum precursor are used in such amounts that based on the total amount of the platinum-carbon catalyst, the content of the metallic platinum is 50-70 wt %, preferably 60-70 wt %, the content of the carbonaceous support is 30-50 wt %, preferably 30-40 wt %. From the perspective of further improving the activity and stability of the prepared platinum-carbon catalyst, the process according to the present invention preferably further comprises a step S0, in which the carbonaceous material in step S1 is pretreated. In step S0, the carbonaceous material is successively subjected to solvent treatment, first oxidizing treatment, second oxidizing treatment and high-temperature treatment, to produce a pretreated carbonaceous material. Moreover the pretreated carbonaceous material is used in step S1.

In the solvent treatment, the carbonaceous material is soaked in an organic solvent to produce an organic solvent-soaked carbonaceous material. The organic solvent is one or two or more of ketone solvents (for example C₃-C₆ ketones), preferably acetone. The soaking can be carried out at ordinary temperature or at an elevated temperature. Preferably, the temperature of the organic solvent is 20-70° C., preferably 20-50° C., more preferably 25-40° C. The duration time of the soaking can be selected according to the temperature of soaking, generally, the duration time of the soaking can be 5-24 hours, preferably 8-12 hours. The used amount of the organic solvent should be sufficient to submerge the carbonaceous material. Generally, the volume ratio of the solvent to the carbonaceous material can be 5-100:1, preferably 8-50:1, more preferably 10-30:1.

After the soaking is completed during the solvent treatment, the solid and liquid phases can be separated using conventional methods (e.g. filtering), and the obtained solid phase can be dried to produce the organic solvent-soaked carbonaceous material. The drying can be performed at a temperature of 50-120° C., preferably at a temperature of 60-80° C. The duration time of the drying can be 5-24 hours, preferably 8-12 hours. The drying can be performed under normal pressure or under reduced pressure conditions.

In the first oxidizing treatment, the organic solvent-soaked carbonaceous material comes into contact with a first oxidizing agent to produce a first oxidizing-treated carbonaceous material, the first oxidizing agent is one or two or more of hydrogen peroxide and organic peroxides represented by formulae II:

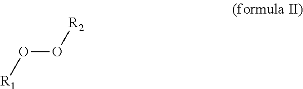

In formula II, R₁ and R₂ are each selected from H, C₄-C₁₂ alkyl, C₆-C₁₂ aryl, C₇-C₁₂ aralkyl and

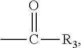

and R₁ and R₂ are not H at the same time, R₃ is C₄-C₁₂ linear or branched alkyl or C₆-C₁₂ aryl.

In the present invention, specific examples of C₄-C₁₂ alkyl may include, but are not limited to n-butyl, sec-butyl, isobutyl, tert-butyl, n-pentyl, neopentyl, isopentyl, tert-pentyl, hexyl (including various isomers of hexyl), cyclohexyl, octyl (including various isomers of octyl), nonyl (including various isomers of nonyl), decyl (including various isomers of decyl), undecyl (including various isomers of undecyl) and dodecyl (including various isomers of dodecyl).

In the present invention, specific examples of C₆-C₁₂ aryl may include, but are not limited to phenyl, naphthyl, methylphenyl and ethylphenyl.

In the present invention, specific examples of C₇-C₁₂ aralkyl may include, but are not limited to phenylmethyl, phenylethyl, phenyl-n-propyl, phenyl-n-butyl, phenyl-tert-butyl, phenyl-isopropyl, phenyl-n-pentyl and phenyl-n-butyl.

Specific examples of the organic peroxide may include, but are not limited to tert-butyl hydroperoxide, cumene hydroperoxide, ethylbenzene hydroperoxide, cyclohexyl hydroperoxide, diisopropylbenzene peroxide, dibenzoyl peroxide, di-tert-butyl peroxide, and lauroyl peroxide.

Preferably, the first oxidizing agent is hydrogen peroxide.

In the first oxidizing treatment, in the presence of a liquid dispersion medium, the organic solvent-soaked carbonaceous material comes into contact with the first oxidizing agent in the liquid phase.

The liquid dispersion medium can be water and/or C₁-C₄ alcohol, preferably water. In a preferred embodiment, the first oxidizing agent is dissolved in the liquid dispersion medium to form a first oxidizing agent solution, and the first oxidizing agent solution comes into contact with the organic solvent-soaked carbonaceous material. In this preferred embodiment, a hydrogen peroxide solution is preferably used as the first oxidizing agent solution. In the hydrogen peroxide solution, the concentration of hydrogen peroxide can be 8-30 wt %, preferably 10-20 wt %.

In the first oxidizing treatment, the contacting is preferably performed at a temperature of 20-70° C., preferably at a temperature of 25-50° C., more preferably at a temperature of 25-40° C. The duration time of the contacting can be selected according to the contacting temperature, and it is preferably 5-24 hours, more preferably 8-12 hours. The used amount of the first oxidizing agent can be selected according to the amount of the organic solvent-soaked carbonaceous material. The mass ratio of the first oxidizing agent to the organic solvent-soaked carbonaceous material can be 5-30:1, preferably 10-25:1.

In the first oxidizing treatment, after the treatment with the first oxidizing agent is completed, the solid and liquid phases can be separated using conventional methods (e.g. filtering), and the obtained solid phase is dried to produce the first oxidizing-treated carbonaceous material. The drying can be performed at a temperature of 80-120° C., preferably at a temperature of 90-110° C. The duration time of the drying can be 5-24 hours, preferably 8-24 hours. The drying can be performed under normal pressure or under reduced pressure conditions.

In the second oxidizing treatment, the first oxidizing-treated carbonaceous material comes into contact with a second oxidizing agent to produce a second oxidizing-treated carbonaceous material, and the second oxidizing agent is HNO₃ and/or H₂SO₄. Preferably, the second oxidizing agent is HNO₃. The mass ratio of the second oxidizing agent to the second oxidizing-treated carbonaceous material is 5-50:1, preferably 10-30:1, more preferably 12-20:1.

In the second oxidizing treatment, in the presence of the liquid dispersion medium, the first oxidizing-treated carbonaceous material comes into contact with a second oxidizing agent. The liquid dispersion medium can be water and/or C₁-C₄ alcohol, preferably water. In a preferred embodiment, the second oxidizing agent is dissolved in the liquid dispersion medium to form a second oxidizing agent solution, and the second oxidizing agent solution comes into contact with the first oxidizing-treated carbonaceous material. In this preferred embodiment, nitrate acid is preferably used as the second oxidizing agent solution. The concentration of the nitrate acid can be 25-68 wt %, preferably 30-40 wt %.

In the second oxidizing treatment, the contacting is preferably performed at a temperature of 50-90° C., more preferably at a temperature of 55-80° C., further preferably at a temperature of 60-75° C. In the second oxidizing treatment, the duration time of the contacting can be selected according to the temperature of the contacting, preferably, the duration time of the contacting can be 5-24 hours, preferably 5-12 hours.

In the second oxidizing treatment, after the treatment with the second oxidizing agent is completed, the solid and liquid phases can be separated using conventional methods (e.g. filtering), and the obtained solid phase is dried to produce the second oxidizing-treated carbonaceous material. The drying can be performed at a temperature of 80-120° C., and the duration time of the drying can be 5-15 hours, preferably 8-12 hours. The drying can be performed under normal pressure or under reduced pressure conditions.

In the high-temperature treatment, the second oxidizing-treated carbonaceous material is calcined in an inert atmosphere at a temperature of 300-700° C., preferably 500-600° C. to produce a pretreated carbonaceous material. The inert atmosphere can be an atmosphere formed by nitrogen gas and/or zero group gases, for example, an atmosphere formed by one or two or more gases of nitrogen gas, argon gas, and helium gas. The duration time of the calcining can be selected according to the calcining temperature, preferably, the duration time of the calcining can be 2-8 hours, preferably 3-6 hours.

According to the process of the present invention, in step S1, a carbonaceous material, a platinum precursor, a complexing agent and a dispersion medium are dispersed with an ultrasonic wave, and the carbonaceous material can be fully mixed with the platinum precursor. Preferably, relative to per 1 litre of dispersion medium, the power of ultrasonic wave can be 1-20 W, preferably 2-12 W. The duration time of the ultrasonic dispersion can be 0.2-1 hours. The carbonaceous material, the platinum precursor, the complexing agent and the dispersion medium can be dispersed in common ultrasonic dispersion devices.

According to the process of the present invention, in the dispersion formed in step S1, the platinum content in the liquid phase of the first dispersion is relatively low, and the adhesion rate of the platinum precursor on the carbonaceous material is high. According to the process of the present invention, the molar concentration of the platinum precursor relative to the dispersion medium is C₀, wherein C₀=m_{Pt}/V_{dispersion} medium, wherein, m_{Pt} is the molar amount of the platinum precursor (in mole), V_{dispersion medium} is the volume of the dispersion medium (in liter); the molar concentration of platinum in the liquid phase of the first dispersion obtained from step S1 is C₁, C₁/C₀<0.5. Preferably, C₁/C₀ is 0.15-0.49. More preferably, C₁/C₀ is 0.15-0.45. Further preferably, C₁/C₀ is 0.2-0.4.

In the present invention, the molar concentration C₁ of platinum in the liquid phase of the first dispersion is determined by inductively coupled plasma emission spectrometry (ICP method). The specific testing method is as follows: (1) measuring the mass and volume of the first dispersion; (2) Quantitatively taking out a certain volume of the dispersion from the first dispersion, the volume of which is V₁; (3) Filtering the dispersion having a volume of V₁ through a mobile phase filter (its filter membrane has a pore size of 0.22 m), washing the solid phase with deionized water, collecting the filtered liquid and the washing solution to obtain a liquid phase, the total volume of which is denoted as V₂; then taking a sample from the liquid phase and measuring the molar concentration of platinum in the liquid phase by ICP, denoted as C₂. The molar concentration of platinum in the first dispersion: C₁=C₂×V₂/V₁.

According to the process of the present invention, in step S2, the pH value of the first dispersion obtained from step S1 is adjusted to 8-14, preferably adjusted to 8-12. A pH-value regulator can be added to the first dispersion to adjust the pH value to 8-14, preferably 8-12. The pH-value regulator is preferably one or two or more of sodium carbonate, potassium carbonate, ammonia, potassium hydroxide and sodium hydroxide. The pH-value regulator is preferably provided in form of an aqueous solution, and the concentration of the aqueous solution can be conventionally selected without special limitation.

According to the process of the present invention, in step S3, the reducing agent is an acidic organic reducing agent. Preferably, the reducing agent is one or two or more of formic acid, citric acid and tartaric acid. More preferably, the reducing agent contains formic acid. Further preferably, the reducing agent is formic acid.

According to the process of the present invention, in step S3, the used amount of the reducing agent exceeds the stoichiometric ratio. The molar ratio of the reducing agent to the platinum precursor as platinum element is generally 5-1000:1. Preferably, the molar ratio of the reducing agent to the platinum precursor as platinum element is 50-600:1. More preferably, the molar ratio of the reducing agent to the platinum precursor as platinum element is 80-400:1. Further preferably, the molar ratio of the reducing agent to the platinum precursor as platinum element is 100-200:1.

According to the process of the present invention, in step S3, the reducing agent comes into contact with the second dispersion at 50-140° C. In a preferred embodiment, in step S3, the reducing agent comes into contact with the second dispersion at 55-90° C. for the reduction reaction. According to this preferred embodiment, the dispersion uniformity of metallic platinum particles on the carbonaceous support in the finally prepared platinum-carbon catalyst can be further improved, and the platinum metal particles can have a more uniform particle size. In this preferred embodiment, in step S3, the reducing agent more preferably comes into contact with the second dispersion at 60-80° C. for the reduction reaction.

In step S3, the duration time of the reduction reaction can be selected according to the temperature at which the reduction reaction is performed. Generally, in step S3, the duration time of the reduction reaction can be 2-12 hours, preferably 4-10 hours, more preferably 6-8 hours. In step S3, the reduction reaction is performed in an inert atmosphere, for example, in an atmosphere formed by nitrogen gas and/or zero group gases (for example, argon gas and/or helium gas).

In a preferred embodiment, the reduction reaction is performed at 60-80° C. by contacting, and the duration time of the reduction reaction is 6-8 hours. According to this preferred embodiment, the activity and stability of the finally prepared platinum-carbon catalyst can be further improved.

According to the process of the present invention, conventional separation methods can be employed to separate a solid phase substance from the reduction mixture obtained in step S3. The separated solid phase substance is successively water-washed and dried to produce the platinum-carbon catalyst.

Generally, the solid-liquid separation of the reduction mixture obtained in step S3 can be achieved through one or a combination of two or more of filtering, centrifugation and sedimentation, thereby producing the solid phase substance. The drying can be the heat drying or the freeze drying. The heat drying can be performed at a temperature of 55-85° C., preferably at a temperature of 60-70° C.; and the freeze drying can be performed at a temperature of −30° C. to 5° C. The duration time of the drying can be selected according to the drying manner and the drying temperature, and it generally can be 4-24 hours, preferably 5-15 hours.

According to the third aspect of the present invention, the present invention provides a platinum-carbon catalyst prepared with the process of the second aspect of the present invention.

In the platinum-carbon catalyst prepared with the process of the second aspect of the present invention, at least 50% of metallic platinum particles have a contact angle relative to the support of 70° or less, for example, 50-75% of metallic platinum particles have a contact angle relative to the support of 70° or less. Preferably, at least 55% of metallic platinum particles have a contact angle relative to the support of 70° or less, for example, 55-70% of metallic platinum particles have a contact angle relative to the support of 70° or less. More preferably, at least 60% of metallic platinum particles have a contact angle relative to the support of 70° or less. In the platinum-carbon catalyst prepared with the process of the second aspect of the present invention, the contact angles of metallic platinum particles relative to the carbonaceous support are generally in the range of 40° to 70°.

For the platinum-carbon catalyst prepared with the process of the second aspect of the present invention, metallic platinum particles in the platinum-carbon catalyst have an average particle size of 3-6 nm.

The platinum-carbon catalyst prepared with the process of the second aspect of the present invention exhibits an increased electrochemical active surface area. The platinum-carbon catalyst prepared with the process of the second aspect of the present invention has an electrochemical active surface area (ECSA) of 70 m²·g⁻¹-Pt or above, preferably 70-120 m²·g⁻¹-Pt, more preferably 80-120 m²·g⁻¹-Pt. The platinum-carbon catalyst according to the present invention has a mass specific activity of 0.2 A mg 1-Pt or higher, preferably 0.2-0.25 A·mg⁻¹-Pt.

The platinum-carbon catalyst according to the present invention is particularly suitable for the fuel cell. According to the fourth aspect of the present invention, the present invention provides use of the platinum-carbon catalyst according to the first aspect or the third aspect of the present invention in fuel cell.

According to the fifth aspect of the present invention, the present invention provides a hydrogen fuel cell, wherein the anode and/or the cathode of the hydrogen fuel cell contain the platinum-carbon catalyst according to the first aspect or the third aspect of the present invention.

The present invention will be described in detail below with reference to the examples, but the scope of the present invention will not be limited thereby.

In the following examples and comparative examples, transmission electron microscopy analysis was performed on a transmission electron microscope model Tecnai G2 F20 purchased from FEI Company. The sample preparation method was as follows: taking about 1 mg of the sample and dispersing it in a 60-80 wt % ethanol aqueous solution, ultrasonically dispersing for 10 minutes, using a pipette to take a small amount of the dispersion, and adding it dropwise onto the copper grid used for electron microscopy testing. The copper grid used was a micro-grid or an ultra-thin micro-grid, and neither ultra-thin carbon film nor carbon supporting film was used.

The specific method for determining the contact angle of the metal platinum particles relative to the support in the platinum-carbon catalyst was as follows: selecting monolayer particles (that is, no overlapping of multiple Pts/C), adjusting the transmission electron microscope to the bright field mode, and selecting an observation perspective area where the hemispherical surface (approximate spherical surface) of Pt particles could be seen; as shown in FIG. 1, obtaining the contact angle (0) from a straight line being the plane of the carbon layer and a tangent line plotted at the contact arc of the Pt particle and the carbon support surface; and selecting 8 different perspective areas, and counting and recording the contact angles of platinum particles in the perspective area.

The specific method for measuring the particle size of metallic platinum particles in the platinum-carbon catalyst was as follows: subjecting a sample to transmission electron microscope analysis, and randomly selecting eight perspective areas of non-overlapped and widely dispersed catalyst particles (magnification: 40000-200000 fold), randomly selecting 50 metal platinum particles from each area (400 in total), measuring and recording the particle sizes of the particles, and finally taking the average value of particle sizes as the average particle size of the metallic platinum particles.

In the following examples and comparative examples, the molar concentration C₁ of platinum in the liquid phase of the first dispersion, which was formed after the ultrasonic treatment, was determined by inductively coupled plasma emission spectrometry (ICP method). The specific testing method was as follows: (1) measuring the mass and volume of the first dispersion; (2) Quantitatively taking out a certain volume of the dispersion from the first dispersion, the volume of which was V₁; ((3) Filtering the dispersion having a volume of V₁ through a mobile phase filter (its filter membrane had a pore size of 0.22 m), washing the solid phase with deionized water, collecting the filtered liquid and the washing solution to obtain a liquid phase, the total volume of which was denoted as V₂; then taking a sample from the liquid phase and measuring the molar concentration of platinum in the liquid phase by ICP, denoted as C₂. The molar concentration of platinum in the first dispersion: C₁=C₂×V₂/V₁.

In the following examples and comparative examples, the composition of the platinum carbon catalyst was measured by inductively coupled plasma emission spectrometry (ICP method).

In the following examples and comparative examples, the electrochemical activity of the platinum-carbon catalyst could be measured according to GB/T0042.4-2009 (Proton Exchange Membrane Fuel Cells—Part 4: Test method for electrocatalysts). Specifically, the test method could be a rotating disk test method, where the catalyst was prepared into a slurry and drop-coated on glassy carbon electrodes with a diameter of 5 mm, and dried for testing (ensuring that the Pt loading on the electrode was within the range of 18-22 μg/cm²); the test conditions of the catalyst polarization curve were: 0.1M HClO₄ solution, oxygen gas saturation, voltage scanning range was 0-1.0V vs RHE (Reversible Hydrogen Electrode), scanning rate was 10 mV/s, the rotation rate of rotating disk electrode was 1600 r/min; the test method of electrochemical active surface area (ECSA) was hydrogen underpotential deposition (HUPD) method, which was based on the adsorption and desorption of hydrogen atoms on the metal surface, the test conditions were: 0.1M HClO₄ solution, nitrogen gas saturation, voltage scanning range was 0-1.0V vs RHE, scanning rate was 50 mV/s. For example, monolayer hydrogen atoms were adsorbed on the Pt surface cathode, and the desorption at the anode could be represented by the CV peak in the range of ˜0.05 to ˜0.4 V vs. RHE. The specific integration method of the CV peak: using the left extension line of the horizontal tangent at the lowest point of the upper curve near 0.4-0.6V of the CV curve as the baseline of the peak, subtracting the double-layer current, and integrating the hydrogen atom desorption and adsorption area above the baseline to obtain the area S_{H}. Then the calculation formula for the electrochemical active surface area (ECSA) of the platinum-carbon catalyst was as follows:

$$ECSA = \frac{{S}_{H} / V}{0.21 ( mC \cdot {cm}^{- 2} ) \cdot {M}_{pt}}$$

wherein S_{H} was the peak area, the unit was A*V (ampere*volt)
V was the scanning rate, which was 0.05 v/s, and the unit was V/s (volt/second)
Mₚₜ was the mass of Pt dropped on the glassy carbon electrode, in grams;

The calculation formula for the mass specific activity (A/mg_{Pt}) of the platinum-carbon catalyst was:

$$The mass specific activity = \frac{{i}_{k}}{1000 \times {m}_{Pt}}$$

wherein, iₖ was the kinetic current in mA/cm², and its calculation was based on the K-L equation, as follows:

$$\frac{1}{i} = \frac{1}{{i}_{k}} + \frac{1}{{i}_{L}}$$

i_{L} was the limit diffusion current, which could be read directly from the ORR curve;
m_{Pt} was the amount of Pt loaded on the glassy carbon electrode, in mg_{Pt}/cm².

The following examples and comparative examples related to the following conductive carbon blacks:
(1) Conductive carbon black with the brand name Ketjen EC300J, purchased from Lion of Japan, with a particle size of 50-100 nm and a specific surface area of 1200 m²/g;
(2) Conductive carbon black with the brand name Ketjen EC600J, purchased from Lion of Japan, with a particle size of 50-100 nm and a specific surface area of 1500 m²/g;
(3) Conductive carbon black with the brand name Vulcan XC72, purchased from Carbter, with a particle size of 50-100 nm and a specific surface area of 260 m²/g.

Examples 1-11 served to illustrate the present invention.

### Example 1

### (1) Conductive Carbon Black Pretreatment-Step S0

Ketjen EC600J conductive carbon black (hereinafter “conductive carbon black” sometimes also referred to as “carbon black”) was soaked in acetone (analytical grade) at 25° C. for 8 hours, wherein the mass ratio of acetone to conductive carbon black was 20:1. After the soaking was completed, a suction filtration was performed to obtain a solid phase substance, which was dried at 65° C. for 12 hours to obtain an acetone-soaked conductive carbon black.

The acetone-soaked conductive carbon black and a hydrogen peroxide solution having a mass concentration of 15% were mixed (the mass ratio of hydrogen peroxide to carbon black was 25:1), and reacted at 25° C. for 12 hrs. After the reaction was completed, the reaction mixture was suction filtered. The filter cake was washed three times with distilled water, and then suction dried. The obtained solid phase substance was dried at 110° C. for 24 hrs to produce a first oxidizing-treated conductive carbon black.

The first oxidizing-treated carbon black and an aqueous nitrate acid solution having a mass concentration of 30% were mixed (the mass ratio of HNO₃ to carbon black was 15:1), and reacted at 70° C. for 12 hrs. After the reaction was completed, the reaction mixture was suction filtered. The obtained solid phase substance was dried at 110° C. for 12 hrs to produce a second oxidizing-treated conductive carbon black.

The second oxidizing-treated carbon black was calcined at 600° C. in an atmosphere of nitrogen gas for 4 hrs to produce a pretreated conductive carbon black.

### (2) Preparation of the Dispersion-Steps S1 and S2

### Step S1

819 g of the pretreated conductive carbon black was added to a mixed solution of 175 L of deionized water and 262 L of ethylene glycol. After mixing evenly, 700 g of sodium acetate was added, followed by the addition of an aqueous chloroplatinic acid solution (containing 5.7 mol of chloroplatinic acid). The resulting mixture was ultrasonically dispersed to form a dispersion, wherein the mass ratio of carbon black:chloroplatinic acid:water:ethylene glycol:complexing agent was 1.17:3.33:250:416.7:1, the power of ultrasonic wave was 1000 W, the time of ultrasonic dispersion was 0.5 hrs. A sample was taken from the dispersion to analyze the molar concentration of platinum in the liquid phase of the dispersion, denoted as C₁. The molar concentration of the platinum precursor relative to the dispersion medium was C₀ (determined by the feed ratio, similarly hereinafter). C₁/C₀=0.23.

The pH of the dispersion obtained after ultrasonic treatment was 2.

### Step S2

Sodium carbonate was added to the dispersion obtained after ultrasonic treatment to adjust the pH value of the dispersion to 12.

### (3) Reduction Reaction-Step S3

The pH value-adjusted dispersion was heated to 75° C. using a heater. Formic acid as reducing agent was added with stirring to perform a reduction reaction, wherein the molar ratio of the reducing agent to chloroplatinic acid was 200:1. After the addition of the reducing agent was completed, the heating conditions of the heater were maintained, and the reaction was continued for 6 hrs.

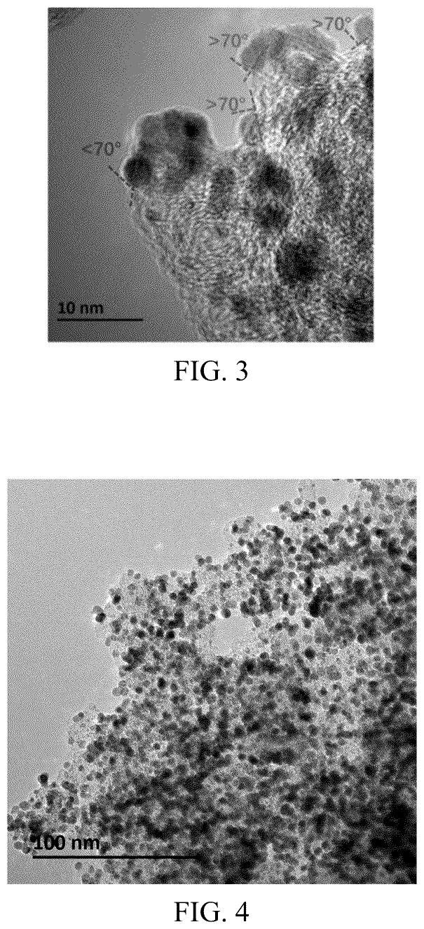

After the reaction was completed, the reduction reaction mixture was filtered to collect a solid phase substance. The solid phase substance was then washed with deionized water until the mass concentration of Cl⁻ in the filtrate was less than 50 ppm. The washed solid phase substance was vacuum dried at 60° C. for 12 hrs. The dried solid phase substance was ground to obtain 1000 g of platinum-carbon catalyst. Upon measurement, the mass content of platinum in the platinum-carbon catalyst was 54.5%, represented as Pt/C-55%. A sample was taken from the platinum-carbon catalyst for analysis to determine that 69% of the metallic platinum in the platinum-carbon catalyst had a contact angle relative to the support of 700 or less (as shown in FIG. 2). Measurement revealed that the average particle size of platinum particles in the platinum-carbon catalyst was 3.6 nm (as shown in FIG. 3). The electrochemical property of the prepared platinum-carbon catalyst was measured, and the experimental results are listed in Table 1.

### Example 2

The same procedure as in Example 1 was used to prepare platinum-carbon catalysts, except that in step S0, the second oxidizing-treated conductive carbon blacks were calcined in an atmosphere of nitrogen gas at 400° C., 500° C., and 700° C. respectively to produce the pretreated conductive carbon blacks. The obtained platinum-carbon catalysts were represented as Pt/C-55%-400, Pt/C-55%-500, and Pt/C-55%-700 respectively.

In step S1, a sample was taken from the dispersion to analyze the concentration of platinum in the liquid phase of the dispersion, denoted as C₁. The molar concentration of the platinum precursor relative to the dispersion medium was C₀. C₁/C₀ were 0.39 (400° C.), 0.28 (500° C.), and 0.31 (700° C.) respectively.

Measurement revealed that in Pt/C-55%-400, 64% of metallic platinum had a contact angle relative to the support of 70° or less; in Pt/C-55%-500, 67% of metallic platinum had a contact angle relative to the support of 700 or less; in Pt/C-55%-700, 66% of metallic platinum had a contact angle relative to the support of 70° or less. Upon measurement, the obtained platinum-carbon catalysts all had average particle sizes of metallic platinum particles within a range of 3-6 nm. The electrochemical property of the prepared platinum-carbon catalysts was measured, and the experimental results are listed in Table 1.

### Example 3

The same procedure as in Example 1 was used to prepare platinum-carbon catalysts, except that in step S2, potassium carbonate and sodium hydroxide were respectively added to the dispersion obtained after ultrasonic treatment to adjust the pH of the dispersion to 12. The obtained platinum-carbon catalysts were represented as Pt/C-55%-potassium carbonate and Pt/C-55%-sodium hydroxide respectively.

Measurement revealed that in Pt/C-55%-potassium carbonate, 56% of metallic platinum had a contact angle relative to the support of 70° or less; in Pt/C-55%-sodium hydroxide, 58% of metallic platinum had a contact angle relative to the support of 700 or less. Upon measurement, the obtained platinum-carbon catalysts all had average particle sizes of metallic platinum particles within a range of 3-6 nm. The electrochemical property of the prepared platinum-carbon catalysts was measured, and the experimental results are listed in Table 1.

### Example 4

The same procedure as in Example 1 was used to prepare platinum-carbon catalysts, except that in step S2, sodium carbonate was added to the dispersion obtained after ultrasonic treatment to adjust the pH of the dispersion to 8 and 12 respectively. The obtained platinum-carbon catalysts were represented as Pt/C-55%-pH-8 and Pt/C-55%-pH-10 respectively.

Measurement revealed that in Pt/C-55%-pH-8, 52% of metallic platinum had a contact angle relative to the support of 700 or less; in Pt/C-55%-pH-10, 65% of metallic platinum had a contact angle relative to the support of 700 or less. Upon measurement, the obtained platinum-carbon catalysts all had average particle sizes of metallic platinum particles within a range of 3-6 nm.

The electrochemical property of the prepared platinum-carbon catalysts was measured, and the experimental results are listed in Table 1.

### Comparative Example 1

The same procedure as in Example 1 was used to prepare a platinum-carbon catalyst, except that in step S1, the sodium salt of organic acid and ethylene glycol were not used. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.79; in the prepared platinum-carbon catalyst, 35% of metallic platinum had a contact angle relative to the support of 700 or less (as shown in FIG. 4). The electrochemical property of the prepared platinum-carbon catalysts was measured, and the experimental results are listed in Table 1.

### Comparative Example 2

The same procedure as in Example 2 was used to prepare platinum-carbon catalysts, except that in step S1, the sodium salt of organic acid and ethylene glycol were not used. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.73 (400° C.), C₁/C₀=0.76 (500° C.), C₁/C₀=0.74 (700° C.); in the prepared platinum-carbon catalyst, the contents of metallic platinum having a contact angle relative to the support of 70° or less were respectively 30% (400° C.), 33% (500° C.), and 34% (700° C.). The electrochemical property of the prepared platinum-carbon catalysts was measured, and the experimental results are listed in Table 1.

### Comparative Example 3

The same procedure as in Example 3 was used to prepare platinum-carbon catalysts, except that in step S1, the sodium salt of organic acid and ethylene glycol were not used. In the prepared platinum-carbon catalyst, the contents of metallic platinum having a contact angle relative to the support of 70° or less were respectively 29% (potassium carbonate) and 31% (sodium hydroxide). The electrochemical property of the prepared platinum-carbon catalysts was measured, and the experimental results are listed in Table 1.

### Comparative Example 4

The same procedure as in Example 4 was used to prepare platinum-carbon catalysts, except that in step S1, the sodium salt of organic acid and ethylene glycol were not used. In the prepared platinum-carbon catalyst, the contents of metallic platinum having a contact angle relative to the support of 70° or less were respectively 26% (pH=8) and 30% (pH=10).

The electrochemical property of the prepared platinum-carbon catalysts was measured, and the experimental results are listed in Table 1.

### Comparative Example 5

The same procedure as in Example 1 was used to prepare a platinum-carbon catalyst, except that in step S1, the sodium salt of organic acid was not used. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.65; in the prepared platinum-carbon catalyst, 46% of metallic platinum had a contact angle relative to the support of 700 or less.

The electrochemical property of the prepared platinum-carbon catalysts was measured, and the experimental results are listed in Table 1.

### Comparative Example 6

The same procedure as in Example 1 was used to prepare a platinum-carbon catalyst, except that in step S3, the formic acid as reducing agent was replaced with glucose, the used amount of which was identical to the used amount of formic acid in step S3 of Example 1. In the platinum-carbon catalyst prepared from step S3, 24% of metallic platinum had a contact angle relative to the support of 70° or less. The electrochemical property of the prepared platinum-carbon catalysts was measured, and the experimental results are listed in Table 1.

### Comparative Example 7

The same procedure as in Example 1 was used to prepare a platinum-carbon catalyst, except that in step S3, formic acid as reducing agent was used in such an amount that the molar ratio of the reducing agent to chloroplatinic acid was 2:1. In the platinum-carbon catalyst prepared from step S3, 43% of metallic platinum had a contact angle relative to the support of 70° or less. The electrochemical property of the prepared platinum-carbon catalysts was measured, and the experimental results are listed in Table 1.

### Example 5

The same procedure as in Example 1 was used to prepare a platinum-carbon catalyst, except that step S0 was omitted, and instead Ketjen EC600J conductive carbon black was directly used in step S1 to prepare the dispersion. Namely, the platinum-carbon catalyst was prepared from a non-pretreated conductive carbon black.

In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.43; in the platinum-carbon catalyst prepared from step S3, 51% of metallic platinum had a contact angle relative to the support of 70° or less.

The electrochemical property of the prepared platinum-carbon catalysts was measured, and the experimental results are listed in Table 1.

### Example 6

The same procedure as in Example 1 was used to prepare a platinum-carbon catalyst, except that in step S1, the mass ratio of conductive carbon black:chloroplatinic acid:water:ethylene glycol:complexing agent was 1.17:3.33:300:300:1. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.31; in the platinum-carbon catalyst prepared from step S3, 58% of metallic platinum had a contact angle relative to the support of 700 or less.

The electrochemical property of the prepared platinum-carbon catalysts was measured, and the experimental results are listed in Table 1.

### Comparative Example 8

The same procedure as in Example 1 was used to prepare a platinum-carbon catalyst, except that in step S1, the mass ratio of conductive carbon black:chloroplatinic acid:water:ethylene glycol:complexing agent was 1.17:3.33:30:550:1. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.59; in the platinum-carbon catalyst prepared from step S3, 48% of metallic platinum had a contact angle relative to the support of 700 or less.

The electrochemical property of the prepared platinum-carbon catalysts was measured, and the experimental results are listed in Table 1.

### Example 7

The same procedure as in Example 1 was used to prepare a platinum-carbon catalyst, except that in step S1, the time of ultrasonic dispersion was 0.25 hrs. In step S1, a sample was taken from the dispersion to analyze the concentration of platinum in the liquid phase of the dispersion, denoted as C₁. The molar concentration of the platinum precursor relative to the dispersion medium was C₀. C₁/C₀=0.37; in the platinum-carbon catalyst prepared from step S3, 54% of metallic platinum had a contact angle relative to the support of 70° or less. The electrochemical property of the prepared platinum-carbon catalysts was measured, and the experimental results are listed in Table 1.

### Example 8

The same procedure as in Example 1 was used to prepare a platinum-carbon catalyst, except that in step S3, the molar ratio of the reducing agent to the platinum precursor was 400:1. In the platinum-carbon catalyst prepared from step S3, 58% of metallic platinum had a contact angle relative to the support of 700 or less. The electrochemical property of the prepared platinum-carbon catalysts was measured, and the experimental results are listed in Table 1.

### Example 9

### (1) Conductive Carbon Black Pretreatment-Step S0

Ketjen EC300J conductive carbon black was soaked in acetone (analytically pure) at 35° C. for 8 hours, wherein the mass ratio of acetone to conductive carbon black was 18:1. After the soaking was completed, a suction filtration was performed to obtain a solid phase substance, which was dried at 65° C. for 8 hours to obtain an acetone-soaked conductive carbon black.

The acetone-soaked conductive carbon black and a hydrogen peroxide solution having a mass concentration of 10% were mixed (the mass ratio of hydrogen peroxide to carbon black was 20:1), and reacted at 25° C. for 10 hrs. After the reaction was completed, the reaction mixture was suction filtered.

The obtained solid phase substance was dried at 105° C. for 8 hrs to produce a first oxidizing-treated conductive carbon black.

The first oxidizing-treated conductive carbon black and an aqueous nitrate acid solution having a mass concentration of 35% were mixed (the mass ratio of HNO₃ to conductive carbon black was 12:1), and reacted at 65° C. for 12 hrs. After the reaction was completed, the reaction mixture was suction filtered.

The obtained solid phase substance was dried at 86° C. for 10 hrs to produce a second oxidizing-treated conductive carbon black.

The second oxidizing-treated carbon black was calcined at 600° C. in an atmosphere of nitrogen gas for 4 hrs to produce a pretreated conductive carbon black.

### (2) Preparation of the Dispersion-Steps S1 and S2

### Step S1

The pretreated conductive carbon black was added to a mixed solution of 7.5 L of deionized water and 11.3 L of ethylene glycol. After mixing evenly, 30 g of sodium formate was added, followed by the addition of an aqueous chloroplatinic acid solution. The resulting mixture was ultrasonically dispersed to form a dispersion, wherein the mass ratio of carbon black:chloroplatinic acid:water:ethylene glycol:complexing agent was 1.17:3.33:250:416.7:1, the power of ultrasonic wave was 300 W, and the time of ultrasonic dispersion was 0.5 hrs. A sample was taken from the dispersion to analyze the concentration of platinum in the liquid phase of the dispersion, denoted as C₁. The molar concentration of the platinum precursor relative to the dispersion medium was C₀. C₁/C₀=0.35.

The pH of the dispersion obtained after ultrasonic treatment was 3.

### Step S2

Sodium carbonate was added to the dispersion obtained after ultrasonic treatment to adjust the pH value of the dispersion to 12.

### (3) Reduction Reaction-Step S3

The pH value-adjusted dispersion was heated to 65° C. using a heater. Formic acid as reducing agent was added with stirring to perform a reduction reaction, wherein the molar ratio of the reducing agent to chloroplatinic acid was 100:1. After the addition of the reducing agent was completed, the heating conditions of the heater were maintained, and the reaction was continued for 6 hrs.

After the reaction was completed, the reduction reaction mixture was filtered to collect a solid phase substance. The solid phase substance was then washed with deionized water until the mass concentration of Cl⁻ in the filtrate was less than 50 ppm. The washed solid phase substance was vacuum dried at 60° C. for 6 hrs. The dried solid phase substance was ground to obtain a platinum-carbon catalyst having a platinum particle size of 4.7 nm. Upon measurement, the mass content of platinum in the platinum-carbon catalyst was 68%. A sample was taken from the platinum-carbon catalyst for analysis to determine that in the platinum-carbon catalyst, 52% of metallic platinum had a contact angle relative to the support of 70° or less. Measurement revealed that platinum particles in the platinum-carbon catalyst had a particle size of 4.7 nm.

The electrochemical property of the prepared platinum-carbon catalysts was measured, and the experimental results are listed in Table 1.

### Example 10

### (1) Conductive Carbon Black Pretreatment-Step S0

The Vulcan XC72 conductive carbon black was pretreated using the same manner as in Example 9 to obtain a pretreated conductive carbon black.

### (2) Preparation of the Dispersion-Steps S1 and S2

### Step S1

The pretreated conductive carbon black was added to a mixed solution of 15 L of deionized water and 22.5 L of ethylene glycol. After mixing evenly, 60 g of sodium acetate was added, followed by the addition of an aqueous chloroplatinic acid solution. The resulting mixture was ultrasonically dispersed to form a dispersion, wherein the mass ratio of carbon black:chloroplatinic acid:water:ethylene glycol:complexing agent was 4.0:3.33:250:416.7:1, the power of ultrasonic wave was 300 W, the time of ultrasonic dispersion was 0.6 hrs. A sample was taken from the dispersion to analyze the concentration of platinum in the liquid phase of the dispersion, denoted as C₁. The molar concentration of the platinum precursor relative to the dispersion medium was C₀. C₁/C₀=0.4.

The pH of the dispersion obtained after ultrasonic treatment was 12.

### Step S2

Sodium carbonate was added to the dispersion obtained after ultrasonic treatment to adjust the pH value of the dispersion to 9.

### (3) Reduction Reaction-Step S3

The reduction reaction was performed using the same manner as in Example 9, wherein the dispersion was the dispersion prepared in “(2) Preparation of the dispersion” of Example 10. After the reaction was completed, the reduction reaction mixture was filtered to collect a solid phase substance. The solid phase substance was then washed with deionized water until the mass concentration of Cl⁻ in the filtrate was less than 50 ppm. The washed solid phase substance was vacuum dried at 60° C. for 8 hrs to produce a dried solid phase substance, which was ground to produce a platinum-carbon catalyst. Measurement revealed that the platinum-carbon catalyst had a platinum mass content of 39%. A sample was taken from the platinum-carbon catalyst for analysis to determine that in the platinum-carbon catalyst, 67% of metallic platinum had a contact angle relative to the support of 700 or less. Measurement revealed that the average particle size of platinum particles in the platinum-carbon catalyst was in the range of 3.5-4.2 nm. The electrochemical property of the prepared platinum-carbon catalysts was measured, and the experimental results are listed in Table 1.

### Example 11

The same procedure as in Example 10 was used to prepare a platinum-carbon catalyst, except that step S0 was omitted, and instead the carbon black was directly used in step S1 to prepare the dispersion. Namely, the platinum-carbon catalyst was prepared from a non-pretreated carbon black, wherein in step S1, a sample was taken from the dispersion to analyze the concentration of platinum in the liquid phase of the dispersion, denoted as C₁. The molar concentration of the platinum precursor relative to the dispersion medium was C₀. C₁/C₀=0.49; in step S3, a sample was taken for analysis to determine that 51% of metallic platinum had a contact angle relative to the support of 70° or less.

The electrochemical property of the prepared platinum-carbon catalysts was measured, and the experimental results are listed in Table 1.

### Comparative Example 9

The same procedure as in Example 10 was used to prepare a platinum-carbon catalyst, except that in step S1, the sodium salt of organic acid and ethylene glycol were not used, wherein in step S1, a sample was taken from the dispersion to analyze the concentration of platinum in the liquid phase of the dispersion, denoted as C₁. The molar concentration of the platinum precursor relative to the dispersion medium was C₀. C₁/C₀=0.74; in step S3, a sample was taken for analysis to determine that, 34% of metallic platinum had a contact angle relative to the support of 700 or less. The electrochemical property of the prepared platinum-carbon catalysts was measured, and the experimental results are listed in Table 1.

### Comparative Example 10

The same procedure as in Example 10 was used to prepare a platinum-carbon catalyst, except that in step S3, the formic acid as reducing agent was replaced with hydrazine hydrate, the used amount of which was identical to the used amount of formic acid in step S3 of Example 1. In step S3, a sample was taken for analysis to determine that 21% of metallic platinum had a contact angle relative to the support of 700 or less. The electrochemical property of the prepared platinum-carbon catalysts was measured, and the experimental results are listed in Table 1.

### Comparative Example 11

The same procedure as in Example 10 was used to prepare a platinum-carbon catalyst, except that in step S3, formic acid as reducing agent was used in such an amount that the molar ratio of the reducing agent to chloroplatinic acid was 2:1. In step S3, a sample was taken for analysis to determine that 45% of metallic platinum had a contact angle relative to the support of 70° or less. The electrochemical property of the prepared platinum-carbon catalysts was measured, and the experimental results are listed in Table 1.

### Example 12

The same procedure as in Example 1 was used to prepare a platinum-carbon catalyst, except that in step S1, 1,2-propylene glycol was used instead of ethylene glycol. The electrochemical property of the prepared platinum-carbon catalysts was measured, and the experimental results are listed in Table 1.

### Example 13

The same procedure as in Example 1 was used to prepare a platinum-carbon catalyst, except that in step S1, 1,3-propylene glycol was used instead of ethylene glycol. The electrochemical property of the prepared platinum-carbon catalysts was measured, and the experimental results are listed in Table 1. FIGS. 2 and 3 are transmission electron microscope (TEM) photos of the platinum-carbon catalysts prepared in Example 1 and Comparative Example 1 respectively. It can be seen from FIGS. 2 and 3 that in the platinum-carbon catalyst prepared in Example 1, the contact angles between most of metallic platinum particles and the support were less than 70°; on the contrary, in the platinum-carbon catalyst prepared in Comparative Example 1, the contact angles between most of metallic platinum particles and the support were greater than 70°.

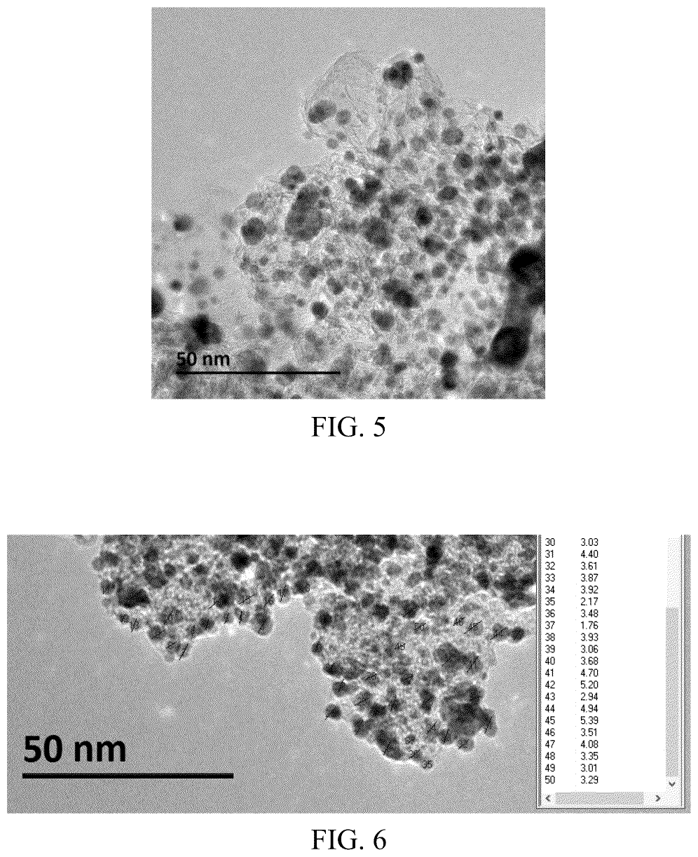

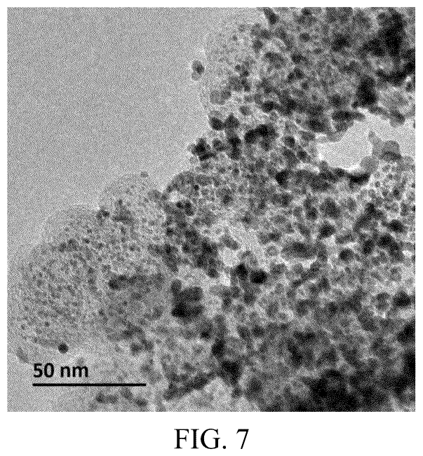

FIGS. 4 and 5 are transmission electron microscope photos of the platinum carbon catalysts prepared in Example 1 and Comparative Example 1 respectively. FIG. 7 is a transmission electron microscope 5 photo of a commercial catalyst (JM HiSPEC 13100-70 wt % Pt/C, abbreviated as JM-70%). It can be seen from the comparison between FIG. 4 and FIGS. 5 and 7 that in the platinum-carbon catalyst prepared in Example 1, the metallic platinum particles had very good dispersion on the support, and the metallic platinum forms cluster particles on the support that were highly even and had a relatively homogeneous size; however, in the platinum-carbon catalyst prepared in Comparative Example 1, the metallic platinum had a relatively poor dispersion on the support, and the size of the metallic platinum particles was not uniform enough. FIG. 6 was a statistical result of the particle size of metal platinum particles in a field of view of a transmission electron microscope photo of the platinum-carbon catalyst prepared in Example 1. It can be seen from FIG. 6 that the particle size of the metal platinum particles in the platinum-carbon catalyst prepared in Example 1 was relatively uniform.

Table 1 lists the electrochemical property test results of the platinum-carbon catalysts prepared in Examples 1-11 and Comparative Examples 1-11. It can be seen from the results in Table 1 that the platinum-carbon catalysts according to the present invention showed the improved stability of electrochemical activity. The amounts of platinum-carbon catalysts prepared in Examples 1-11 were all kilogram-level, indicating that the process according to the present invention can be suitable for the batch production of the platinum-carbon catalyst.

TABLE 1

| | Half-wave | ECSA | Mass Specific |
|---|---|---|---|
| | Potential | (m² · | Activity |
| Sample Source | (V) | g⁻¹-Pt) | (A · mg⁻¹-Pt) |
| Example 1 (Pt/C-55%) | 0.90 | 118.2 | 0.208 |
| Comparative Example 1 | 0.86 | 45.1 | 0.077 |
| JM-70% (commercially available) | 0.88 | 73.4 | 0.187 |
| Example 2 (Pt/C-55%-400° C.) | 0.90 | 72.5 | 0.235 |
| Comparative Example 2 (400° C.) | 0.87 | 65.8 | 0.140 |
| Example 2 (Pt/C-55%-500° C.) | 0.90 | 92.1 | 0.214 |
| Comparative Example 2 (500° C.) | 0.88 | 69.3 | 0.175 |
| Example 2 (Pt/C-55%-700° C.) | 0.90 | 79.6 | 0.238 |
| Comparative Example 2 (700° C.) | 0.88 | 72.2 | 0.197 |
| Example 3 (Pt/C-55% K₂CO₃) | 0.88 | 98.8 | 0.198 |
| Comparative Example 3 (K₂CO₃) | 0.87 | 63.8 | 0.159 |
| Example 3 (Pt/C-55% NaOH) | 0.89 | 70.5 | 0.200 |
| Comparative Example 3 (NaOH) | 0.88 | 65.2 | 0.149 |
| Example 4 (Pt/C-55%-PH-8) | 0.90 | 76.4 | 0.221 |
| Comparative Example 4 (pH = 8) | 0.87 | 59.3 | 0.138 |
| Example 4 (Pt/C-55%-PH-10) | 0.89 | 113.6 | 0.204 |
| Comparative Example 4 (pH = 10) | 0.85 | 47.4 | 0.108 |
| Comparative Example 5 | 0.87 | 54.3 | 0.156 |
| Comparative Example 6 | 0.87 | 56.1 | 0.162 |
| Comparative Example 7 | 0.88 | 67.4 | 0.165 |
| Example 5 | 0.90 | 73.2 | 0.221 |
| Example 6 | 0.90 | 80.6 | 0.207 |
| Comparative Example 8 | 0.87 | 69.5 | 0.167 |
| Example 7 | 0.89 | 90.1 | 0.212 |
| Example 8 | 0.88 | 85.7 | 0.208 |
| Example 9 | 0.89 | 86.1 | 0.201 |
| Example 10 | 0.89 | 115.3 | 0.229 |
| Example 11 | 0.89 | 77.5 | 0.200 |
| Comparative Example 9 | 0.82 | 65.6 | 0.176 |
| Comparative Example 10 | 0.84 | 69.2 | 0.184 |
| Comparative Example 11 | 0.85 | 70.4 | 0.194 |
| Example 12 | 0.87 | 82.4 | 0.211 |
| Example 13 | 0.88 | 87.9 | 0.219 |

The preferred embodiments of the present invention have been described in detail above, but the present invention is not limited thereto. Within the scope of the technical concept of the present invention, various simple modifications can be made to the technical solution of the present invention, including the combination of various technical features in any other suitable manner. These simple modifications and combinations should also be regarded as the disclosed content of the present invention and all belong to the protection scope of the present invention.

1. A platinum-carbon catalyst containing a carbonaceous support and metallic platinum particles supported on the carbonaceous support, characterized in that at least 50% of metallic platinum particles have a contact angle relative to the carbonaceous support of 700 or less,
preferably, at least 55% of metallic platinum particles have a contact angle relative to the carbonaceous support of 70° or less, for example, 55-70% of metallic platinum particles have a contact angle relative to the support of 700 or less, or 60-70% of metallic platinum particles have a contact angle relative to the support of 700 or less;
further preferably, the contact angles of metallic platinum particles relative to the carbonaceous support are in the range of 400 to 70°;
based on the total amount of the platinum-carbon catalyst, the content of the metallic platinum is 20-70 wt %, the content of the carbonaceous support is 30-80 wt %; preferably, based on the total amount of the platinum-carbon catalyst, the content of the metallic platinum is 50-70 wt %, the content of the carbonaceous support is 30-50 wt %.

2. The platinum-carbon catalyst according to claim 1, wherein metallic platinum particles in the platinum-carbon catalyst have an average particle size of 3-6 nm.

3. The platinum-carbon catalyst according to claim 1, wherein the platinum-carbon catalyst substantially consists of the carbonaceous support and metallic platinum particles supported on the carbonaceous support.

4. The platinum-carbon catalyst according to claim 1, wherein the platinum-carbon catalyst consists of the carbonaceous support and metallic platinum particles supported on the carbonaceous support.

5. The platinum-carbon catalyst according to claim 1, wherein the carbonaceous support is a conductive carbon black;
preferably, the conductive carbon black has a specific surface area of 200-2000 m²/g, preferably 250-1500 m²/g.

6. The platinum-carbon catalyst according to claim 1, wherein the platinum-carbon catalyst has an electrochemical active surface area of 70-120 m²·g⁻¹-Pt;
preferably, the platinum-carbon catalyst has a mass specific activity of 0.2 A·mg⁻¹-Pt or higher, preferably 0.2-0.25 A·mg⁻¹-Pt.

7. A process for preparing a platinum-carbon catalyst, the process comprises the following steps:
S1. a carbonaceous material, a platinum precursor, a complexing agent and a dispersion medium are dispersed to produce a first dispersion, the complexing agent is a carboxylate salt, the dispersion medium is C₂-C₄ dihydric alcohol and water, the volume ratio of the dihydric alcohol to water is 0.1-10:1, the molar ratio of the platinum precursor to the complexing agent is 1:0.1-10;
S2. the pH value of the first dispersion is adjusted to 8-14 to produce a second dispersion;
S3. a reducing agent is added to the second dispersion, so that the reducing agent comes into contact with the platinum precursor in the second dispersion for a reduction reaction, the reducing agent is an acidic organic reducing agent, the molar ratio of the reducing agent to the platinum precursor as platinum element is generally 5-1000:1.

8. The process according to claim 7, wherein in step S1, the molar concentration of the platinum precursor relative to the dispersion medium is C₀, the molar concentration of platinum in the liquid phase of the first dispersion obtained from step S1 is C₁, C₁/C₀<0.5, for example, C₁/C₀ is 0.15-0.49;
preferably, C₁/C₀ is 0.15-0.45; more preferably, C₁/C₀ is 0.2-0.4.

9. The process according to claim 7, wherein in step S1, the complexing agent is an alkali metal salt of monocarboxylic acid and/or an ammonium salt of monocarboxylic acid;
preferably, the complexing agent is one or two or more of compounds represented by formula I,
R—COOM (formula I)
in formula I, R is hydrogen, C₁-C₆ alkyl or C₁-C₆ haloalkyl, M is alkali metal ion or ammonium ion;
preferably, the complexing agent is one or two or more of sodium formate, sodium acetate, sodium monochloroacetate, sodium dichloroacetate and sodium trichloroacetate;
preferably, the molar ratio of the platinum precursor to the complexing agent is 1:0.5-5, preferably 1:1-3.

10. The process according to claim 7, wherein in step S1, a carbonaceous material, a platinum precursor, a complexing agent and a dispersion medium are dispersed using ultrasonic wave, relative to per 1 litre of dispersion medium, the ultrasonic wave has a power of 1-20 W, preferably 2-12 W; the duration time of the ultrasonic dispersion is 0.1-5 hours, for example 0.2-1 hours.

11. The process according to claim 7, wherein in step S1, the volume ratio of dihydric alcohol to water is 0.5-5:1, preferably 0.67-3:1, preferably, the dihydric alcohol is ethylene glycol, 1,2-propylene glycol, 1,3-propylene glycol, more preferably, the dihydric alcohol is ethylene glycol.

12. The process according to claim 7, wherein in step S1, the mass ratio of the platinum precursor to the dispersion medium is 1:100-5000, preferably 1:120-1000, more preferably 1:160-300.

13. The process according to claim 7, wherein the process further comprises a step S0, in which the carbonaceous material in step S1 is pretreated, in step S0, the carbonaceous material is successively subjected to solvent treatment, first oxidizing treatment, second oxidizing treatment and high-temperature treatment, to produce a pretreated carbonaceous material,
in the solvent treatment, the carbonaceous material is soaked in an organic solvent to produce an organic solvent-soaked carbonaceous material, preferably, the organic solvent is one or two or more of ketone solvents;
in the first oxidizing treatment, the organic solvent-soaked carbonaceous material comes into contact with a first oxidizing agent to produce a first oxidizing-treated carbonaceous material, the first oxidizing agent is one or two or more of hydrogen peroxide and organic peroxides represented by formulae II: 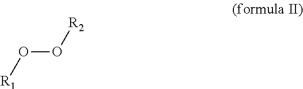
in formula II, R₁ and R₂ are each selected from H, C₄-C₁₂ alkyl, C₆-C₁₂ aryl, C₇-C₁₂ aralkyl and 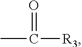
and R₁ and R₂ are not H at the same time, R₃ is C₄-C₁₂ linear or branched alkyl or C₆-C₁₂ aryl;
in the second oxidizing treatment, the first oxidizing-treated carbonaceous material comes into contact with a second oxidizing agent to produce a second oxidizing-treated carbonaceous material, the second oxidizing agent is one or two or more of HNO₃ and/or H₂SO₄;
in the high-temperature treatment, the second oxidizing-treated carbonaceous material is calcined in an inert atmosphere at a temperature of 300-700° C., for example 300-600° C. to produce a pretreated carbonaceous material.

14. The process according to claim 13, wherein in step S0, in the solvent treatment, the duration time of the soaking is 5-24 hours, the mass ratio of the solvent to the carbonaceous material is 5-100:1;
preferably, in the solvent treatment, the temperature of the organic solvent is 20-70° C., preferably 25-40° C.;
preferably, in the solvent treatment, the organic solvent is acetone.

15. The process according to claim 13, wherein in step S0, in the first oxidizing treatment, the duration time of the contacting is 5-24 hours, the mass ratio of the first oxidizing agent to the organic solvent-soaked carbonaceous material is 5-30:1;
preferably, in the first oxidizing treatment, the contacting is performed at a temperature of 20-70° C., preferably 25-40° C.;
preferably, in the first oxidizing treatment, the first oxidizing agent is provided in form of an aqueous solution, the content of the first oxidizing agent in the aqueous solution is 5-30 wt %;
preferably, in the first oxidizing treatment, the first oxidizing agent is hydrogen peroxide.

16. The process according to claim 13, wherein in step S0, in the second oxidizing treatment, the duration time of the contacting is 5-24 hours, the mass ratio of the second oxidizing agent to the first oxidizing-treated carbonaceous material is 5-50:1, preferably 10-30:1, more preferably 12-20:1;
preferably, in the second oxidizing treatment, the contacting is performed at a temperature of 50-90° C.;
preferably, in the second oxidizing treatment, the second oxidizing agent is nitrate acid, preferably the concentration of the nitrate acid is 25-68 wt %, preferably 30-40 wt %.

17. The process according to claim 13, wherein, in step S0, in the high-temperature treatment, the calcining temperature is 500-600° C.;
preferably, in the high-temperature treatment, the duration time of the calcining is 2-8 hours, preferably 3-6 hours.

18. The process according to claim 7, wherein in step S1, the water-soluble platinum precursor is one or two or more of sodium chloroplatinite, ammonium hexachloroplatinate, potassium hexachloroplatinate, sodium hexachloroplatinate, platinum tetrachloride, tetraammineplatinum nitrate, platinum nitrate, chloroplatinic acid, potassium chloroplatinate and sodium chloroplatinate;
preferably, in step S1, the carbonaceous material is a conductive carbon black, the conductive carbon black has a specific surface area of preferably 200-2000 m²/g, more preferably 250-1500 m²/g.

19. The process according to claim 7, wherein in step S2, the pH value of the first dispersion obtained from step S1 is adjusted to 8-12, for example by addition of sodium carbonate, potassium carbonate or sodium hydroxide.

20. The process according to claim 7, wherein in step S3, the reducing agent is one or two or more of formic acid, citric acid and tartaric acid, the reducing agent preferably contains formic acid, more preferably is formic acid;
preferably, in step S3, the molar ratio of the reducing agent to the water-soluble platinum precursor is 50-600:1, preferably 80-400:1, more preferably 100-200:1, the water-soluble platinum precursor is calculated as metallic platinum.

21. The process according to claim 7, wherein in step S3, the reduction is performed at a temperature of 50-140° C., preferably performed at a temperature of 55-90° C., more preferably performed at a temperature of 60-80° C.;
preferably, in step S3, the duration time of the reduction is 2-12 hours.

22. Use of the platinum-carbon catalyst according to any one of claims 1-6 in fuel cell.

23. A hydrogen fuel cell, wherein the anode and/or the cathode of the hydrogen fuel cell contain the platinum-carbon catalyst according to any one of claims 1-6.
